(19) United States
(12) Patent Application Publication
(10) Pub. No.: US 2020/0248838 A1
(43) Pub. Date: Aug. 6, 2020

(54) FLOW RESTRICTOR FOR A PLUG VALVE

(71) Applicant: S.P.M. Flow Control, Inc., Fort Worth, TX (US)

(72) Inventors: Vivek ANANDBABU, Bangalore (IN); Nagendra Udyavara NAYAK, Mangalore (IN); Swapnil URANKAR, Belgaum (IN)

(73) Assignee: S.P.M. Flow Control, Inc., Fort Worth, TX (US)

(21) Appl. No.: 16/756,567

(22) PCT Filed: Oct. 27, 2018
(86) PCT No.: PCT/US2018/057884

§ 371 Date: Apr. 16, 2020

Related U.S. Application Data
(60) Provisional application No. 62/596,494, filed on Dec. 8, 2017.

(30) Foreign Application Priority Data
Oct. 27, 2017 (IN) 201741038150

(51) Int. Cl. F16K 47/08; F16K 5/04

(52) U.S. Cl. CPC F16K 47/08; F16L 55/027; F16K 5/0407

(57) ABSTRACT

A flow restrictor is provided for a plug valve. The flow restrictor includes a restrictor body configured to be at least one of held within an internal bore of a valve body of the plug valve or mounted to the valve body in fluid communication with the internal bore. The restrictor body includes a plurality of fluid passages extending through a length of the restrictor body. The fluid passages include turns such that the fluid passages define tortuous fluid paths through the restrictor body.

### CROSS-REFERENCE TO RELATED APPLICATION

This application claims priority to and the benefit of Indian Provisional Application Number 201741038150, filed on Oct. 27, 2018, and U.S. Provisional Patent Application Ser. No. 62/596,494, filed on Dec. 8, 2017, both of which are incorporated herein by reference for all intents and purposes.

### TECHNICAL FIELD

This disclosure relates to plug valves, and, in particular, to flow restrictors for plug valves used in oilfield operations.

### BACKGROUND OF THE DISCLOSURE

In oilfield operations, plug valves are widely used to control the flow of fluid within a fluid conduit system of the operation. For example, christmas trees, manifolds, fracking flow iron systems, and the like often utilize plug valves to control the flow of fluid into and out of various components. The fluids controlled by the plug valves in oilfield operations often contains solid particulates and/or corrosive material such that the fluid can be abrasive and/or corrosive. For example, fluids used in hydraulic fracturing operations consist of a base fluid (e.g., water, liquefied petroleum gas (LPG), propane, etc.) mixed with one or more other materials (e.g., a slurry, sand, acid, proppant, a sand and base fluid mixture, etc.) to form an abrasive and/or corrosive fracturing fluid, which is sometimes referred to as a “fracking fluid.”

Over time, the flow of the abrasive and/or corrosive fluid through the plug valve and other components of the fluid conduit system can erode and wear down the interior surfaces (e.g., the various internal passages, etc.) and the internal components (e.g., valves, seats, springs, etc.) of the plug valve and other components, which can eventually cause the plug valve and other components to fail. Failure of plug valves and other components of the fluid conduit systems of oilfield operations can have relatively devastating repercussions and/or can be relatively costly.

### SUMMARY

This summary is provided to introduce a selection of concepts in a simplified form that are further described below in the Detailed Description. This summary is not intended to identify key features or essential features of the claimed subject matter. Nor is it intended to be used as an aid in determining the scope of the claimed subject matter.

In a first aspect, a flow restrictor is provided for a plug valve. The flow restrictor includes a restrictor body configured to be at least one of held within an internal bore of a valve body of the plug valve or mounted to the valve body in fluid communication with the internal bore. The restrictor body includes a plurality of fluid passages extending through a length of the restrictor body. The fluid passages include turns such that the fluid passages define tortuous fluid paths through the restrictor body.

In some embodiments, the fluid passages are configured to reduce a pressure of fluid flowing through the restrictor body.

In some embodiments, the restrictor body is configured to be held by a plug of the plug valve. The restrictor body includes a cluster of a plurality of spherical members and openings extending between the spherical members define the fluid passages.

In some embodiments, the restrictor body is configured to be held by a plug of the plug valve. The restrictor body includes a cluster of a plurality of spherical members and an end cap configured to extend between the spherical members and the internal bore of the valve body of the plug valve. The end cap includes at least one opening extending therethrough.

In some embodiments, the flow restrictor includes a conduit having an internal passageway. The conduit is configured to be mounted to the valve body of the plug valve such that the internal passageway fluidly communicates with the internal bore of the valve body. The restrictor body is held within the internal passageway of the conduit.

In some embodiments, the flow restrictor includes a conduit having an internal passageway. The conduit is configured to be mounted to the valve body of the plug valve such that the internal passageway fluidly communicates with the internal bore of the valve body. The restrictor body is held within the internal passageway of the conduit. At least some of the turns of the fluid passages have an angle of approximately 90°.

In a second aspect, a plug valve includes a valve body having an internal bore configured to receive a flow of fluid therethrough, and a plug held by the body such that at least a portion of the plug extends within the internal bore of the valve body. The plug includes a passageway extending therethrough. The plug is rotatable between an open position and a closed position. The passageway of the plug is aligned with the internal bore of the valve body in the open position such that the passageway is in fluid communication with the internal bore in the open position of the plug. The plug forms an obstruction in the closed position such that the closed position of the plug is configured to prevent fluid from flowing through the internal bore of the valve body. The plug includes a flow restrictor extending within passageway. The flow restrictor includes a cluster of a plurality of spherical members.

In some embodiments, the flow restrictor is configured to reduce a pressure of fluid flowing through the internal bore of the valve body.

In some embodiments, openings are defined between the spherical members. The openings define fluid passages that define tortuous fluid paths through the passageway of the plug.

In some embodiments, the spherical members are arranged within the passageway of the plug in a plurality of columns and rows.

In some embodiments, at least one spherical member has a different size as compared to at least one other spherical member.

In some embodiments, the flow restrictor includes an end cap extending between the spherical members and the internal bore of the valve body. The end cap includes at least one opening extending therethrough.

In some embodiments, the spherical members include steel.

In a third aspect, a flow restrictor is provided for a plug valve. The flow restrictor includes a conduit having an internal passageway. The conduit is configured to be mounted to a valve body of the plug valve such that the internal passageway fluidly communicates with an internal bore of the valve body. The flow restrictor includes a restrictor body held within the internal passageway of the conduit. The restrictor body includes a plurality of fluid passages extending through a length of the restrictor body. The fluid passages include turns such that the fluid passages define tortuous fluid paths through the restrictor body.

In some embodiments, the fluid passages are configured to reduce a pressure of fluid flowing through the internal passageway of the conduit.

In some embodiments, at least some of the turns of the fluid passages have an angle of approximately 90°.

In some embodiments, at least some of the turns of the fluid passages have an angle of less than approximately 90°.

In some embodiments, each of the turns of the fluid passages has an angle of approximately 90°.

In some embodiments, the conduit is configured to be mounted to the valve body of the plug valve downstream from a fluid outlet of the plug valve.

In some embodiments, the restrictor body includes steel.

Other aspects, features, and advantages will become apparent from the following detailed description when taken in conjunction with the accompanying drawings, which are a part of this disclosure and which illustrate, by way of example, principles of the inventions disclosed.

### BRIEF DESCRIPTION OF THE DRAWINGS

The accompanying drawings facilitate an understanding of the various embodiments.

FIG. 1 is a cross-sectional view of a plug valve according to an exemplary embodiment.

FIG. 2 is another cross-sectional view of the plug valve shown in FIG. 1 illustrating an open position of the plug valve.

FIG. 3 is another cross-sectional view of the plug valve shown in FIGS. 1 and 2 illustrating a closed position of the plug valve.

FIG. 4 is an enlarged cross-sectional view of a portion of the plug valve shown in FIG. 1 illustrating a flow restrictor according to an exemplary embodiment.

FIG. 5 is a cross-sectional view of a portion of a plug valve illustrating a flow restrictor according to another exemplary embodiment.

FIG. 6 is a cross-sectional view of a plug valve illustrating a flow restrictor according to another exemplary embodiment.

FIG. 7 is a cross-sectional view of the flow restrictor shown in FIG. 6.

FIG. 8 is another cross-sectional view of the flow restrictor shown in FIGS. 6 and 7.

FIG. 9 is a cross-sectional view of a flow restrictor according to another exemplary embodiment.

FIG. 10 is a cross-sectional view of a flow restrictor according to another exemplary embodiment.

FIG. 11 is a cross-sectional view of a plug valve illustrating a flow restrictor according to another exemplary embodiment.

FIG. 12 is a cross-sectional view of a flow restrictor according to another exemplary embodiment.

FIG. 13 is a cross-sectional view of a portion of a plug valve illustrating a flow restrictor according to another exemplary embodiment.

FIG. 14 is a cross-sectional view of a plug valve illustrating a flow restrictor according to another exemplary embodiment.

FIG. 15 is a cross-sectional view of a flow restrictor according to another exemplary embodiment.

Corresponding reference characters indicate corresponding parts throughout the drawings.

### DETAILED DESCRIPTION

Certain embodiments of the disclosure provide a flow restrictor is provided for a plug valve. The flow restrictor includes a restrictor body configured to be at least one of held within an internal bore of a valve body of the plug valve or mounted to the valve body in fluid communication with the internal bore. The restrictor body includes a plurality of fluid passages extending through a length of the restrictor body. The fluid passages include turns such that the fluid passages define tortuous fluid paths through the restrictor body.

Certain embodiments of the disclosure reduce the pressure of fluid flowing through a plug valve. Certain embodiments of the disclosure reduce wear and/or erosion on the interior surfaces of a plug valve. Certain embodiments of the disclosure increase (i.e., extend) the longevity and thus the operational life of a plug valve. Certain embodiments of the disclosure reduce wear and/or erosion and thereby extend the operational life of other components of a piping system that includes a plug valve.

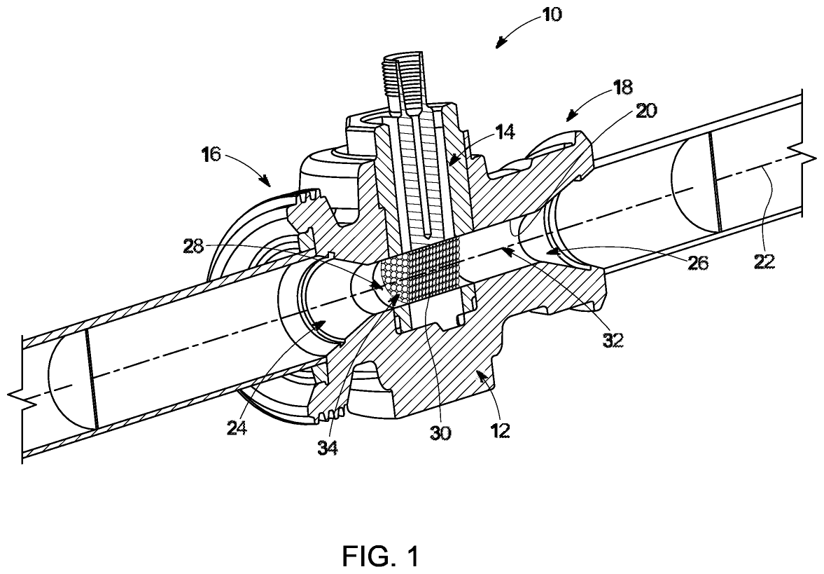

FIGS. 1-3 illustrate a plug valve 10 according to an exemplary embodiment. The plug valve 10 includes a valve body 12 and a plug 14 held by the valve body 12. The valve body 12 extends a length from an end portion 16 to an opposite end portion 18. The valve body 12 includes an internal bore 20 that extends through the length of the valve body 12 along a central longitudinal axis 22. The internal bore 20 is configured to receive a flow of fluid therethrough. In some examples, the internal bore 20 of the plug valve 10 is configured to receive a flow of wellbore fluid, fracking fluid, and/or the like therethrough. The internal bore 20 includes a fluid inlet 24 at the end portion 16 of the valve body 12. A fluid outlet 26 of the internal bore 20 extends through the end portion 18 of the valve body 12.

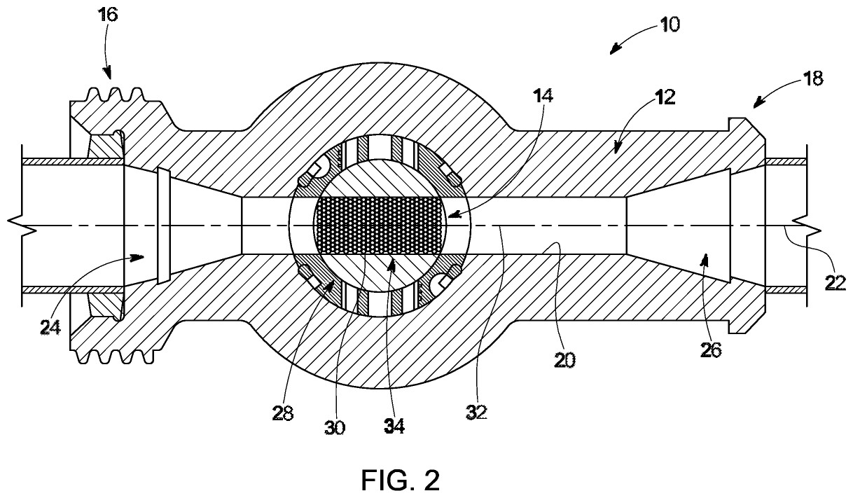

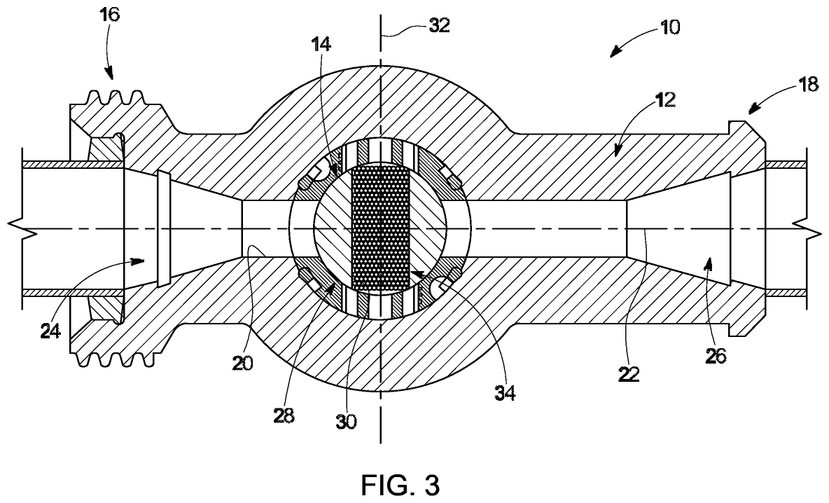

The plug 14 is held by the valve body 12 such that a valve end portion 28 of the plug 14 extends within the internal bore 20 of the valve body 12. The plug 14 includes a passageway 30 that extends through the valve end portion 28 of the plug 14 along a central longitudinal axis 32. The plug 14 is rotatably held by the valve body 12 such that the plug 14 is rotatable between an open position (shown in FIGS. 1 and 2) and a closed position (shown in FIG. 3). In the open position of the plug 14 that is shown in FIGS. 1 and 2, the passageway 30 of the plug 14 is aligned with the internal bore 20 of the valve body 14 such that the passageway 30 is in fluid communication (i.e., fluidly communicates) with the internal bore 20 (e.g., the central longitudinal axes 22 and 32 are aligned with each other, etc.). Accordingly, the open position of the plug 14 allows fluid to flow through the internal bore 20 of the valve body 12. More particularly, fluid entering the internal bore 20 through the fluid inlet 24 can flow through the passageway 30 of the plug 14 and exit the fluid outlet 26 of the internal bore 20 in the open position of the plug 14. In the closed position of the plug 14 that is shown in FIG. 3, the valve end portion 28 of the plug 14 forms an obstruction such that provides a fluid seal within the internal bore 20 of the valve body 12. Accordingly, the closed position of the plug 14 is configured to prevent fluid from flowing through the internal bore 20 of the valve body 12. More particularly, the obstruction formed by the valve end portion 28 of the plug 14 in the closed position prevents fluid that has entered the internal bore 20 through the fluid inlet 24 from flowing through the valve end portion 28 thereby preventing the fluid from exiting the fluid outlet 26 of the internal bore 20.

In some examples, the plug 14 is configured to be manually rotated between the open and closed positions, for example using a lever, a wheel, a crank, and/or the like. In other examples, the plug 14 is configured to be automatically rotated between the open and closed positions using any suitable type of actuator, such as, but not limited to, an electro-mechanical device, an electric motor, a linear actuator (e.g., a ball screw, a lead screw, a rotary screw, another screw-type actuator, a hydraulic linear actuator, a pneumatic linear actuator, a solenoid, a servo, another type of linear actuator, etc.), a hydraulic actuator (e.g., a hydraulic pump system, etc.), a pneumatic actuator, a servo, and/or the like. In some examples, the plug 14 is configured to be both manually and automatically rotated between the open and closed positions.

In some examples, the plug valve 10 is configured to be used within a piping (i.e., fluid conduit) system used in oilfield operations, such as, but not limited to, piping systems used for drilling for oil or natural gas, for cementing a wellbore, for treating a wellbore and/or subterranean formations, for fracturing subterranean formations, and/or the like. For example, the plug valve 10 can be used within a christmas tree of an oilfield operation, to control the flow of fluid into and/or out of a manifold of an oilfield operation, as a fluid connection within a fracking flow iron system, and/or the like.

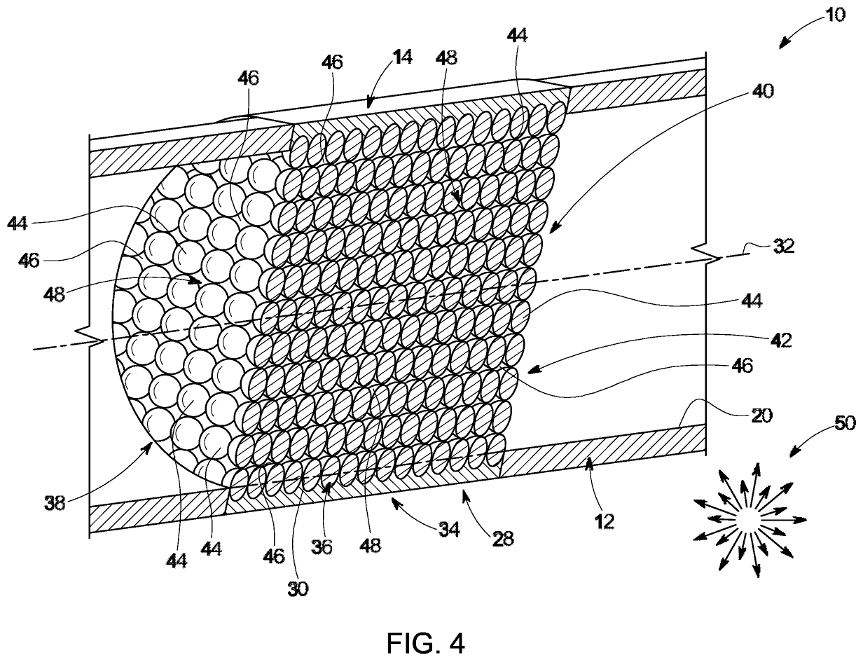

The plug 14 includes a flow restrictor 34 that extends within passageway 30 of the plug 14. As will be described in more detail below, the flow restrictor 34 is configured to reduce a pressure of fluid flowing through the internal bore 20 of the plug valve 10. Referring now to FIG. 4, the flow restrictor 34 includes a restrictor body 36 that is held within the passageway 30 of the valve end portion 28 of the plug 14. Accordingly, the restrictor body 36 of the flow restrictor 34 is held within the internal bore 20 of the valve body 12 of the plug valve 10. The restrictor body 36 extends a length along the central longitudinal axis 32 of the passageway 30 from an inlet side 38 to an outlet side 40.

The restrictor body 36 includes a cluster 42 of a plurality of spherical members 44. More particularly, in the example shown herein, the spherical members 44 are grouped together within the passageway 30 in physical contact with each other, as can be seen in FIG. 3. The spherical members 44 are arranged relative to each other such that openings 46 are defined between adjacent spherical members 44. The openings 46 define fluid passages 48 for fluid to flow through the length of the restrictor body 36 and thereby through the passageway 30 of the plug 14. The fluid passages 48 define tortuous fluid paths through the restrictor body 36 and thereby through the passageway 30 of the plug 14. More particularly, fluid flowing through the fluid passages 48 defined by the openings 46 must flow between and around adjacent spherical members 44 to thereby flow through the length of the restrictor body 36. By flowing between and around the spherical members 44, fluid flowing through the length of the restrictor body 36 takes numerous turns (e.g., along the directions 50, etc.) as the fluid flows along the length of the restrictor body 36. In other words, the fluid passages 48 include turns such that each fluid passage 48 defines a tortuous fluid path along the length of (i.e., through) the restrictor body 36. It should be understood that adjacent spherical members 44 may move relative to each other and/or separate from each other during the flow of fluid through the restrictor body 36.

The tortuous fluid paths of the fluid passages 48 reduce the pressure of fluid flowing through the length of the restrictor body 36 by reducing the velocity energy of the fluid flow. The tortuous fluid paths of the fluid passages 48 thereby reduce the pressure of fluid flowing through the internal bore 20 of the plug valve 10. In some examples, the restrictor body 36 of the flow restrictor 34 is configured to provide a laminar, transition, and/or turbulent fluid flow downstream from the flow restrictor 34.

Non-limiting examples of the pressure reduction of fluid flowing through the plug valve 10 provided by the flow restrictor 34 include a pressure drop of at least approximately 5,000 pounds per square inch (psi), at least approximately 10,000 psi, at least approximately 14,000 pounds per square inch (psi), approximately 14,395 psi, at least approximately 15,000, between approximately 5,000 psi and approximately 15,000 psi, and/or the like. Non-limiting examples of a maximum velocity of fluid flowing through the plug valve 10 include approximately 3,000 feet per second (ft/s), approximately 2,000 ft/s, approximately 1,200 ft/s, approximately 1166 ft/s, approximately 1018 ft/s, and/or the like.

Reducing the pressure of fluid flowing through the plug valve 10 reduces wear and/or erosion on the interior surfaces of the plug valve 10 (e.g., the internal bore 20, the passageway 30, etc.), which can increase (i.e., extend) the longevity and thus the operational life of the plug valve 10. Reducing the pressure of fluid flowing through the plug valve 10 can also reduce wear and/or erosion and thereby extend the operational life of other components of a piping system that includes the plug valve 10, such as, but not limited to, other valves, seats, springs, gates, manifolds, pipes, conduits, pumps, stuffing boxes, and/or the like.

In the exemplary embodiment of the flow restrictor 34, the spherical members 44 are arranged within the passageway 30 of the plug 14 in a substantially uniform pattern of plurality of rows and columns, as can be seen in FIG. 4. But, additionally or alternatively the spherical members 44 can have any other relative arrangement within the passageway 30 that provides the cluster 42 of the spherical members 44 with any pattern that enables the flow restrictor 34 to function as described and/or illustrated herein. In some examples, the spherical members 44 are arranged in a random, arbitrary, non-uniform, and/or the like pattern within the passageway.

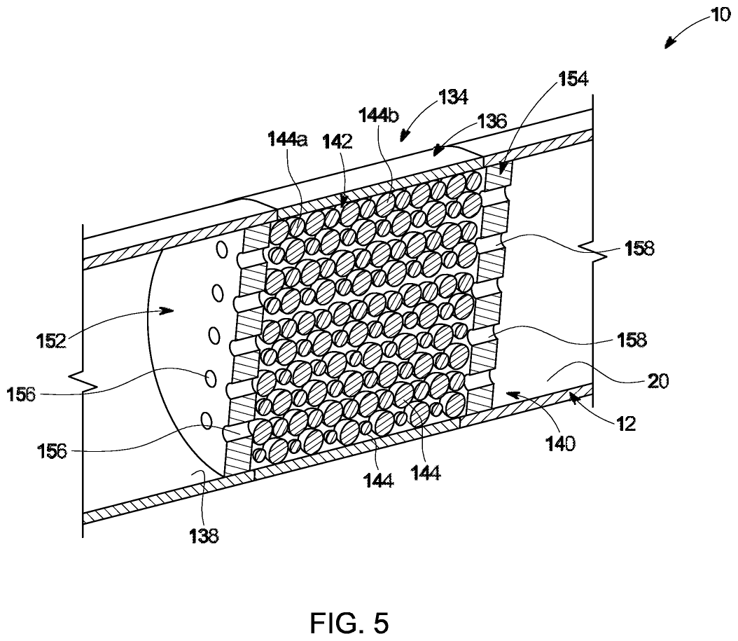

The spherical members 44 of the exemplary embodiment of the flow restrictor 34 shown herein have an approximately uniform size relative to each other. In other words, each of the spherical members 44 has approximately the same size in the exemplary embodiment. But, one or more of the spherical members 44 can have a different size as compared one or more other spherical members 44 in other embodiments. Any number of different sizes of the spherical members 44 can be provided. For example, FIG. 5 illustrates another exemplary embodiment of a flow restrictor 134 that includes two different sizes of spherical members 144. More particularly, the flow restrictor 134 includes a restrictor body 136 that includes a cluster 142 of spherical members 144a having a smaller size and spherical members 144b having a larger size as compared to the spherical members 144a. As can be seen in FIG. 5, the spherical members 144a and 144b of the example of FIG. 5 are arranged in a plurality of rows and columns with an alternating pattern of the spherical members 144a and 144b within each row and column.

Referring again to FIG. 4, the spherical members 44 can be fabricated from any material(s). In some examples, the spherical members 44 are fabricated from steel, such as, but not limited to, tool steel (e.g., S2 tool steel, etc.), stainless steel (e.g., 316 stainless steel, etc.), and/or the like. The material(s) of the spherical members 44 can be selected to reduce corrosion, erosion, and/or the like of the spherical members 44 resulting from fluid flow through the restrictor body 36, which can increase the operational life of the spherical members 44 and thereby the flow restrictor 34.

In some other embodiments, one or more of the spherical members 44 has a different curved three-dimensional shape instead of the spherical shape shown and described herein (e.g., an ovoid, a pebble shape, etc.). Any number of different curved three-dimensional shapes of the spherical members 44 can be provided.

Various parameters of the flow restrictor 34 can be selected to provide a predetermined pressure reduction, maximum velocity, and/or the like. Examples of parameters selected to provide a predetermined pressure reduction, maximum velocity, and/or the like include, but are not limited to, the number of spherical members 44, the sizes of the spherical members 44, the material(s) of the spherical members 44, the number of different sizes of the spherical members 44, the length of the restrictor body 36, the type of fluid flow (e.g., laminar, transition, turbulent, etc.) provided by the flow restrictor 34 downstream from the flow restrictor 34, the shapes of the fluid passages 48, the shapes of the fluid paths defined by the fluid passages 48, the shapes of the spherical members 44, the number of different shapes of the spherical members 44, the pattern, arrangement, and/or the like of the spherical members 44, and/or the like.

Optionally, the flow restrictor 34 includes one or more end caps (e.g., the end cap 152 shown in FIG. 5, etc.) that extend between the spherical members 44 and the internal bore 20 of the valve body 12. For example, and referring again to FIG. 5, the flow restrictor 134 includes an end cap 152 that extends between the spherical members 144 and the internal bore 20 of the valve body 12 at an inlet side 138 of the restrictor body 136. In the example of FIG. 5, the flow restrictor 134 also includes an end cap 154 that extends between the spherical members 144 and the internal bore 20 of the valve body 12 at an outlet side 140 of the restrictor body 136. Each of the end caps 152 and 154 includes one or more respective openings 156 and 158 that enable fluid to pass therethrough. The end caps 152 and 154 can facilitate the pressure reduction provided by the flow restrictor 134.

Each end cap 152 and 154 can include any number of openings 156 and 158, respectively. Moreover, each opening 156 and 158 can have any size. In some examples, one or more of the openings 156 has a different size as compared to one or more of other openings 156, and/or one or more of the openings 158 has a different size as compared to one or more of other openings 158. The patterns of the openings 156 and 158 shown herein are meant as exemplary only. In other examples, the openings 156 and/or 158 are arranged in any other pattern. The number, size(s), pattern, and/or the like of the openings 156 and 158 can be selected to provide a predetermined pressure reduction, maximum velocity, and/or the like of fluid flowing downstream from flow restrictor 134.

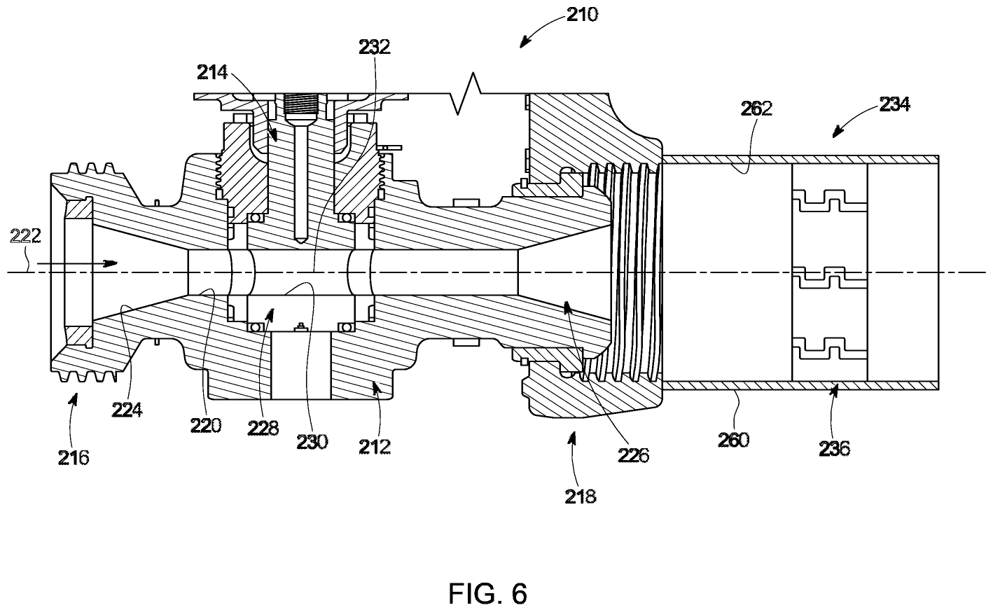

FIG. 6 illustrates a plug valve 210 and another embodiment of a flow restrictor 234 for use with a plug valve (e.g., the plug valve 210, etc.). The plug valve 210 includes a valve body 212 and a plug 214 held by the valve body 212. The valve body 212 extends a length from an end portion 216 to an opposite end portion 218. The valve body 212 includes an internal bore 220 that extends through the length of the valve body 212 along a central longitudinal axis 222. The internal bore 220 is configured to receive a flow of fluid therethrough. In some examples, the internal bore 220 of the plug valve 210 is configured to receive a flow of wellbore fluid, fracking fluid, and/or the like therethrough. The internal bore 220 includes a fluid inlet 224 at the end portion 216 of the valve body 212. A fluid outlet 226 of the internal bore 220 extends through the end portion 218 of the valve body 212.

The plug 214 is held by the valve body 212 such that a valve end portion 228 of the plug 214 extends within the internal bore 220 of the valve body 212. The plug 214 includes a passageway 230 that extends through the valve end portion 228 of the plug 214 along a central longitudinal axis 232. The plug 214 is rotatably held by the valve body 212 such that the plug 214 is rotatable between an open position shown in FIG. 6 and a closed position (not shown). The open position of the plug 214 allows fluid to flow through the internal bore 220 of the valve body 212. The closed position of the plug 214 is configured to prevent fluid from flowing through the internal bore 220 of the valve body 212. The plug 214 can be configured to be manually and/or automatically rotated between the open and closed positions. In some examples, the plug valve 210 is configured to be used within a piping (i.e., fluid conduit) system used in oilfield operations. For example, the plug valve 210 can be used within a christmas tree of an oilfield operation, to control the flow of fluid into and/or out of a manifold of an oilfield operation, as a fluid connection within a fracking flow iron system, and/or the like.

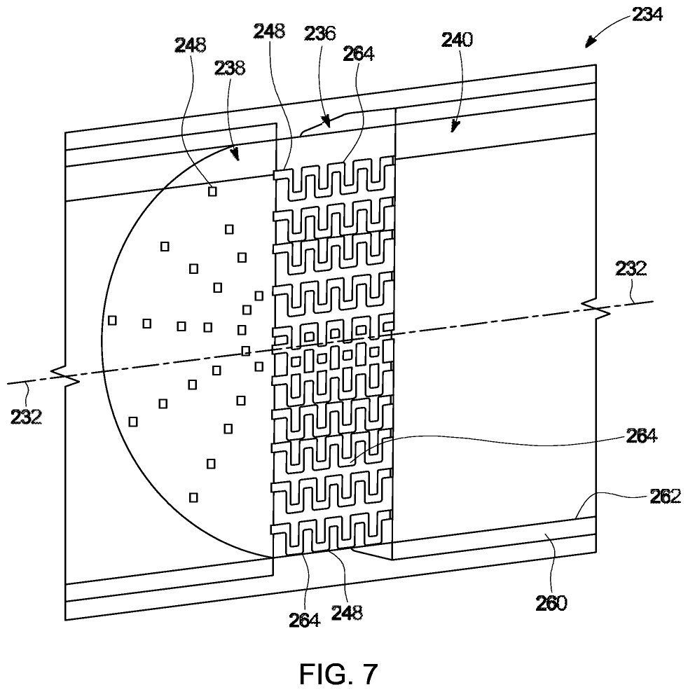

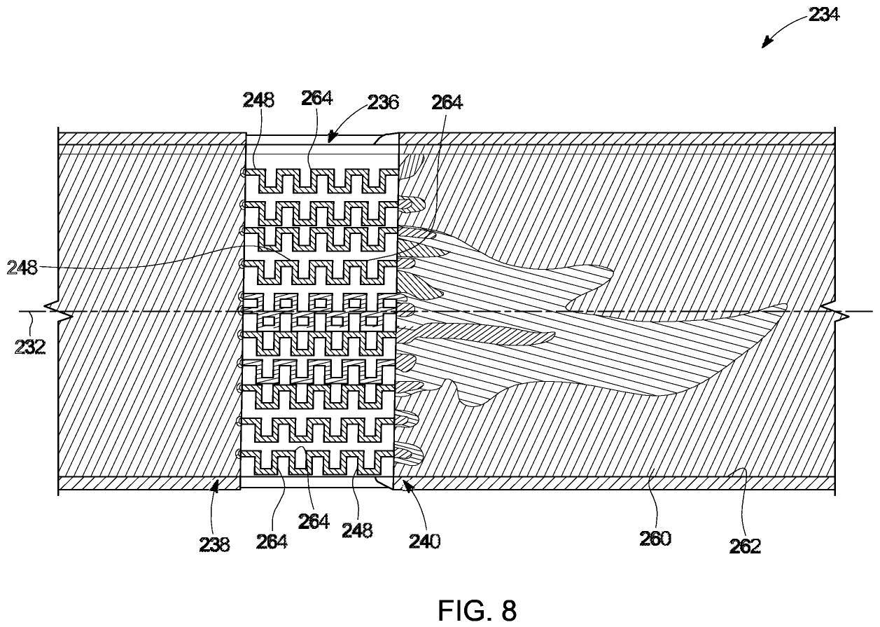

Referring now to FIGS. 7 and 8, the flow restrictor 234 includes a conduit 260 and a restrictor body 236. The conduit 260 includes an internal passageway 262. The conduit is configured to be mounted to the valve body 212 (FIG. 6) of the plug valve 210 (FIG. 6) such that the internal passageway 262 fluidly communicates with the internal bore 220 (FIG. 6) of the valve body 212 (FIG. 6), as is shown in FIG. 6. In the exemplary embodiment of the flow restrictor 234, the conduit 260 is mounted to the valve body 212 of the plug valve 210 downstream from the fluid outlet 226 of the plug valve 210. More specifically, the conduit 260 is mounted to the end portion 218 of the valve body 212 such that the internal passageway 262 of the conduit 260 fluidly communicates with the fluid outlet 226 of the internal bore 220 of the valve body 212. Accordingly, the restrictor body 236 of the flow restrictor 234 is downstream from the plug valve 210 in the exemplary embodiment. In other embodiments, the conduit 260 is mounted to the end portion 216 of the valve body 212 such that the internal passageway 262 of the conduit 260 fluidly communicates with the fluid inlet 224 of the internal bore 220 of the valve body 212. In other words, the flow restrictor 234 can be mounted to the plug valve 210 such that the restrictor body 236 is upstream from the plug valve 210.

The flow restrictor 234 is configured to reduce the pressure of fluid flowing through the internal passageway 262 of the conduit 260 and thereby through the plug valve 210. More particularly, the restrictor body 236 of the flow restrictor 234 is held within the internal passageway 262 of the conduit 260. In some alternative embodiments, the flow restrictor 234 is held within the passageway 230 of the plug 214 of the plug valve 210. The restrictor body 236 extends a length along a central longitudinal axis 232 of the internal passageway 262 from an inlet side 238 to an outlet side 240. The restrictor body 236 includes a plurality of fluid passages 248 that extend through the length of the restrictor body 236 for enabling fluid to flow through the length of the restrictor body 236 and thereby through the internal passageway 262 of the fluid conduit 260. The fluid passages 248 define tortuous fluid paths through the length of the restrictor body 236. More particularly, the fluid passages 248 include turns 264 such that each fluid passage 248 defines a tortuous fluid path along the length of (i.e., through) the restrictor body 236.

The tortuous fluid paths of the fluid passages 248 reduce the pressure of fluid flowing through the length of the restrictor body 236 by reducing the velocity energy of the fluid flow. The tortuous fluid paths of the fluid passages 248 thereby reduce the pressure of fluid flowing through the internal passageway 262 and thus through the internal bore 220 of the plug valve 210. In some examples, the fluid passages 248 are configured to provide a laminar, transition, and/or turbulent fluid flow downstream from the flow restrictor 234.

Non-limiting examples of the pressure reduction of fluid flowing through the plug valve 210 provided by the flow restrictor 234 include a pressure drop of at least approximately 5,000 pounds per square inch (psi), at least approximately 10,000 psi, at least approximately 14,000 pounds per square inch (psi), approximately 14,395 psi, at least approximately 15,000, between approximately 5,000 psi and approximately 15,000 psi, and/or the like. Non-limiting examples of a maximum velocity of fluid flowing through the plug valve 210 include approximately 3,000 feet per second (ft/s), approximately 2,000 ft/s, approximately 1,200 ft/s, approximately 1166 ft/s, approximately 1018 ft/s, and/or the like.

Reducing the pressure of fluid flowing through the plug valve 210 reduces wear and/or erosion on the interior surfaces of the plug valve 210 (e.g., the internal bore 220, etc.), which can increase (i.e., extend) the longevity and thus the operational life of the plug valve 210. Reducing the pressure of fluid flowing through the plug valve 210 can also reduce wear and/or erosion and thereby extend the operational life of other components of a piping system that includes the plug valve 210, such as, but not limited to, other valves, seats, springs, gates, manifolds, pipes, conduits, pumps, stuffing boxes, and/or the like.

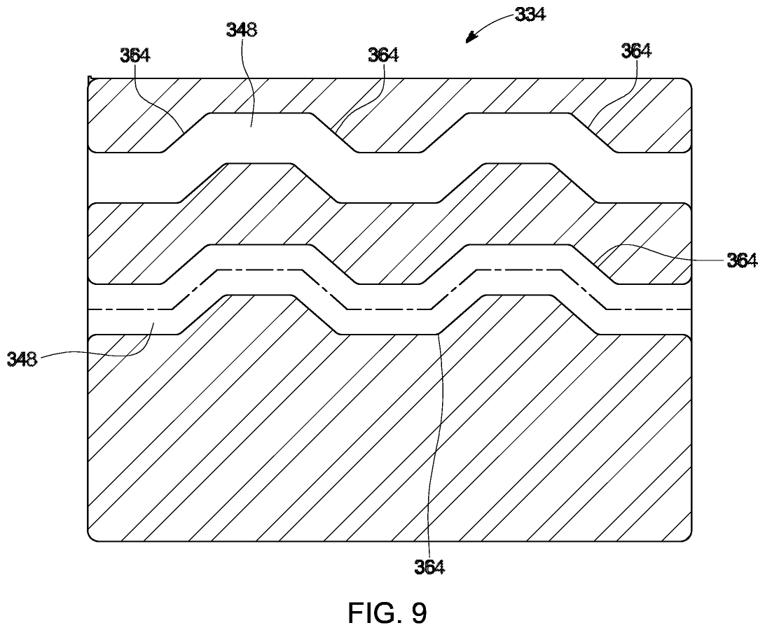

The restrictor body 236 can include any number of the fluid passages 248, and each fluid passage 248 can include any number of turns 264. In the exemplary embodiment, each turn 264 of each fluid passage 248 has an angle of approximately 90°, as can be seen in FIGS. 7 and 8. But, each turn 264 can have any other angle that is greater than approximately 1°. For example, in some embodiments, one or more turns 264 has an angle of less than approximately 90°. FIG. 9 illustrates another exemplary embodiment of a flow restrictor 334 having fluid passages 348 that include turns 364 having angles of less than approximately 90°.

Referring again to FIGS. 7 and 8, although each of the turns 264 is shown in FIGS. 7 and 8 as having the same angle, in other embodiments one or more turns 264 has a different angle as compared to one or more other turns 264 of the same fluid passage 248 and/or one or more other fluid passages 248. Moreover, although each of the fluid passages 248 has the same number of turns 264 in the exemplary embodiment of the flow restrictor 234, in other embodiments one or more fluid passages 248 has a different number of turns 264 as compared to one or more other fluid passages 248. Embodiments wherein one or more fluid passages 248 has a different number of turns 264 and/or one or more differently angled turns 264 as compared to one or more other fluid passages 248 can thereby provide fluid passages 248 that have differently shaped fluid paths.

The restrictor body 236 of the flow restrictor 234 can be fabricated from any material(s). In some examples, the restrictor body 236 is fabricated from steel, such as, but not limited to, tool steel (e.g., S2 tool steel, etc.), stainless steel (e.g., 316 stainless steel, etc.), and/or the like. The material(s) of the restrictor body 236 can be selected to reduce corrosion, erosion, and/or the like of the restrictor body 236 resulting from fluid flow through the restrictor body 236, which can increase the operational life of the restrictor body 236 and thereby the flow restrictor 234.

Various parameters of the flow restrictor 234 can be selected to provide a predetermined pressure reduction, maximum velocity, and/or the like. Examples of parameters selected to provide a predetermined pressure reduction, maximum velocity, and/or the like include, but are not limited to, the number of fluid passages 248, the size of the fluid passages 248, the material(s) of the restrictor body 236, the length of the restrictor body 236, the type of fluid flow (e.g., laminar, transition, turbulent, etc.) provided by the flow restrictor 234 downstream from the flow restrictor 234, the shapes of the fluid passages 248, the shapes of the fluid paths defined by the fluid passages 248, the number of different shapes of the fluid passages 248, the pattern, arrangement, and/or the like of the fluid passages 248, the number of the turns 264, the angles of the turns 264, and/or the like.

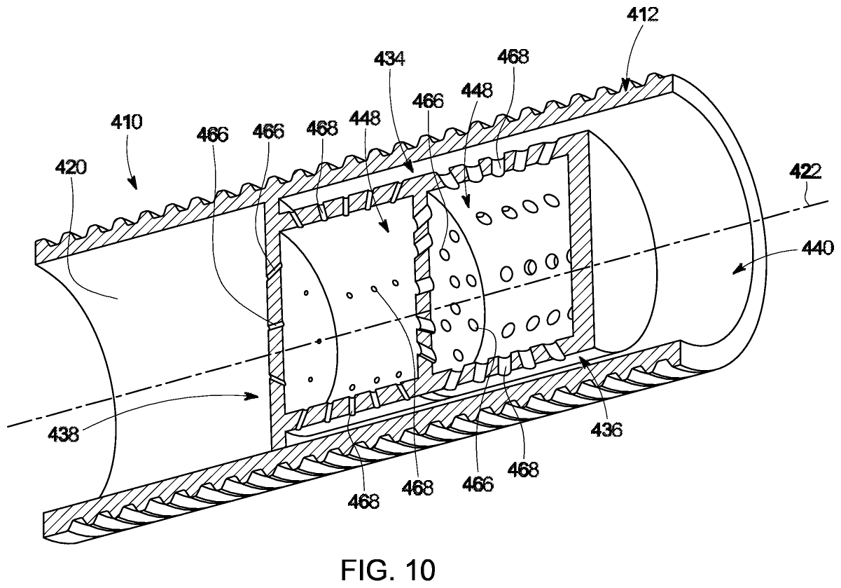

FIG. 10 illustrates another embodiment of a flow restrictor 434 for use with a plug valve 410. In the exemplary embodiment of the flow restrictor 434, a restrictor body 436 of the flow restrictor 434 is held within an internal bore 420 of a valve body 412 of the plug valve 410, for example downstream from a plug (not shown) of the plug valve 410 or upstream from the plug. Alternatively, the flow restrictor 434 can be mounted to the valve body 412 in fluid communication with the internal bore 420 at a fluid inlet (not shown) of the plug valve 410 (i.e., upstream from the plug valve 410) or at a fluid outlet (not shown) of the plug valve 410 (i.e., downstream from the plug valve 410). In still other embodiments, the flow restrictor 434 can be held within a passageway (not shown) of the plug.

The flow restrictor 434 is configured to reduce the pressure of fluid flowing through the flow restrictor 434 and thereby through the plug valve 410. More particularly, the restrictor body 436 extends a length along a central longitudinal axis 422 of the internal bore 420 from an inlet side 438 to an outlet side 440. The restrictor body 436 includes a plurality of chambers 448 that define fluid passages for enabling fluid to flow through the restrictor body 436. The chambers 448 include inlet openings 466 that extend through the restrictor body 436 along the central longitudinal axis 422 for allowing fluid to flow into the chambers 448 axially along the central longitudinal axis 422. The chambers 448 include outlet openings 468 that extend through restrictor body 436 radially outward relative to the central longitudinal axis 422 such that fluid flows out of the chambers 448 into the internal bore 420 in radially outward directions.

The fluid flow axially into the chambers 448 and radially outward from the chambers 448 into the internal bore 420 reduces the pressure of fluid flowing through the restrictor body 436 and thereby the internal bore 420 by reducing the velocity energy of the fluid flow. In some examples, the restrictor body 436 is configured to provide a laminar, transition, and/or turbulent fluid flow downstream from the flow restrictor 434.

Although two are shown, the restrictor body 436 can include any number of the chambers 448, each which can have any size. Moreover, the restrictor body 436 can include any number of the openings 466 arranged in any pattern, and any number of the openings 468 arranged in any pattern. Each opening 466 and each opening 468 can have any size. The number and/or size of the chambers 448, the number, pattern, and/or sizes of the openings 466 and/or 468, and/or the like can be selected to provide a predetermined pressure reduction, maximum velocity, and/or the like.

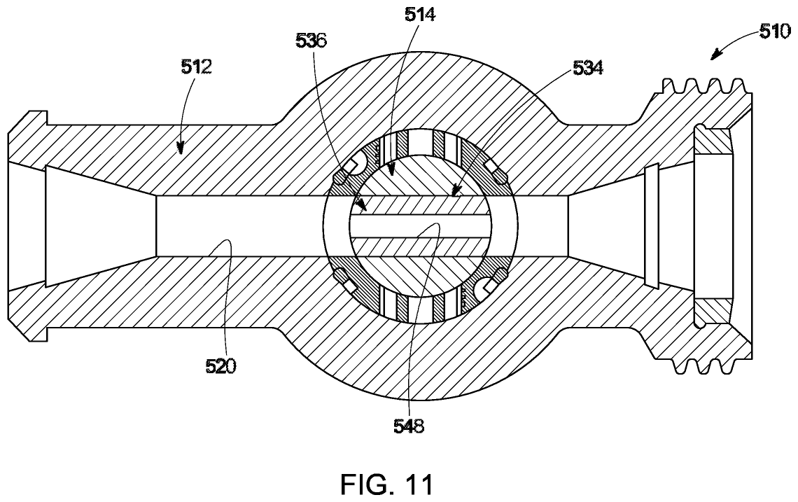

FIG. 11 illustrates another embodiment of a flow restrictor 534 for use with a plug valve 510. In the exemplary embodiment of the flow restrictor 534, a restrictor body 536 of the flow restrictor 534 is held within a passageway 530 of a plug 514 of the plug valve 510, as can be seen in FIG. 11. Alternatively, the restrictor body 536 is held within an internal bore 520 of a valve body 512 of the plug valve 510 or is mounted to the valve body 512 in fluid communication with the internal bore 520.

The flow restrictor 534 is configured to reduce the pressure of fluid flowing through the flow restrictor 534 and thereby through the plug valve 510. More particularly, the restrictor body 536 includes an internal fluid passage 548 that has a size (e.g., a width, a diameter, etc.) that is smaller than the size (e.g., width, diameter, etc.) of the internal bore 520 of the valve body 512 of the plug valve 510, as can be seen in FIG. 11. In other words, the internal fluid passage 548 defines a restricted opening as compared to the internal bore 520. The smaller size of the internal fluid passage 548 as compared to the internal bore 520 reduces the pressure of fluid flowing through the internal bore 520 (and thus the plug valve 510) by reducing the velocity energy of the fluid flow. In some examples, the restrictor body 536 is configured to provide a laminar, transition, and/or turbulent fluid flow downstream from the flow restrictor 534. The size of the internal fluid passage 548 relative to the size of the internal bore 520 can be selected to provide a predetermined pressure reduction, maximum velocity, and/or the like.

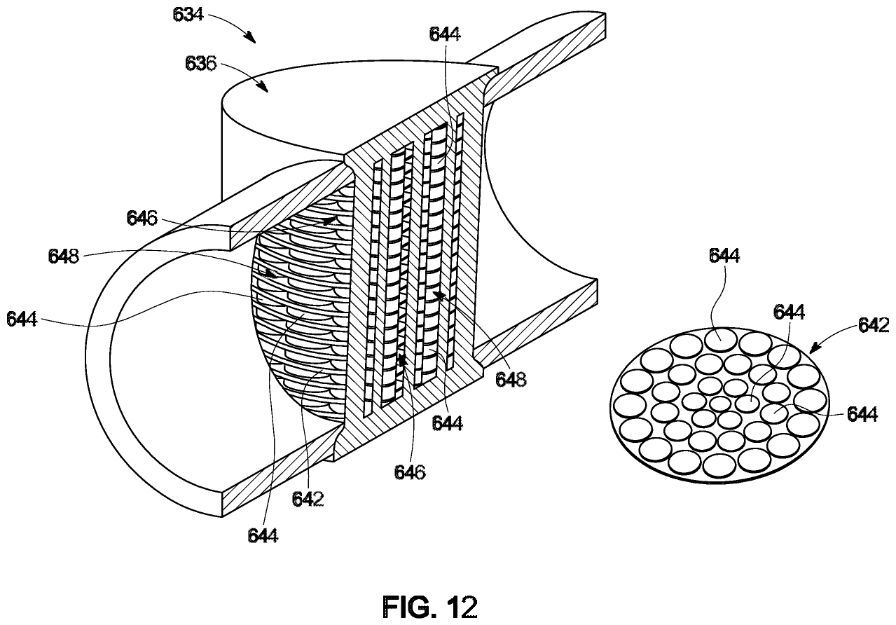

FIG. 12 illustrates another embodiment of a flow restrictor 634 for use with a plug valve (not shown). In the exemplary embodiment of the flow restrictor 634, a restrictor body 636 of the flow restrictor 634 is mounted to a valve body (not shown) of the plug valve in fluid communication with an internal bore (not shown) of the valve body at a fluid inlet (not shown) or a fluid outlet (not shown) of the plug valve. In other embodiments, the restrictor body 636 is held within the internal bore of the valve body downstream from a plug (not shown) of the plug valve or upstream from the plug. In still other embodiments, the restrictor body 636 of the flow restrictor 634 is held within a passageway (not shown) of the plug.

The flow restrictor 634 is configured to reduce the pressure of fluid flowing through the flow restrictor 634 and thereby through the plug valve. More particularly, the restrictor body 636 includes plates 642 arranged in a stack. Each plate 642 includes a plurality of nodule members 644 protruding therefrom. Openings 646 are defined between adjacent nodule members 644 and the plates 642. The openings 646 define fluid passages 648 for fluid to flow through the 636. The fluid passages 648 define tortuous fluid paths through the restrictor body 636.

The tortuous fluid paths of the fluid passages 648 reduce the pressure of fluid flowing through the restrictor body 636 by reducing the velocity energy of the fluid flow. The tortuous fluid paths of the fluid passages 648 thereby reduce the pressure of fluid flowing through the internal bore of the plug valve. In some examples, the restrictor body 636 of the flow restrictor 634 is configured to provide a laminar, transition, and/or turbulent fluid flow downstream from the flow restrictor 634. The material(s) of the nodule members 644 can be selected to reduce corrosion, erosion, and/or the like of the nodule members 644 resulting from fluid flow through the restrictor body 636

Various parameters of the flow restrictor 634 can be selected to provide a predetermined pressure reduction, maximum velocity, and/or the like. Examples of parameters selected to provide a predetermined pressure reduction, maximum velocity, and/or the like include, but are not limited to, the number of plates 642, the number of nodule members 644, the sizes of the nodule members 644, the material(s) of the nodule members 644, the number of different sizes of the nodule members 644, the length of the restrictor body 636, the type of fluid flow (e.g., laminar, transition, turbulent, etc.) provided by the flow restrictor 634 downstream from the flow restrictor 634, the shapes of the fluid passages 648, the shapes of the fluid paths defined by the fluid passages 648, the shapes of the nodule members 644, the number of different shapes of the nodule members 644, the pattern, arrangement, and/or the like of the nodule members 644, and/or the like.

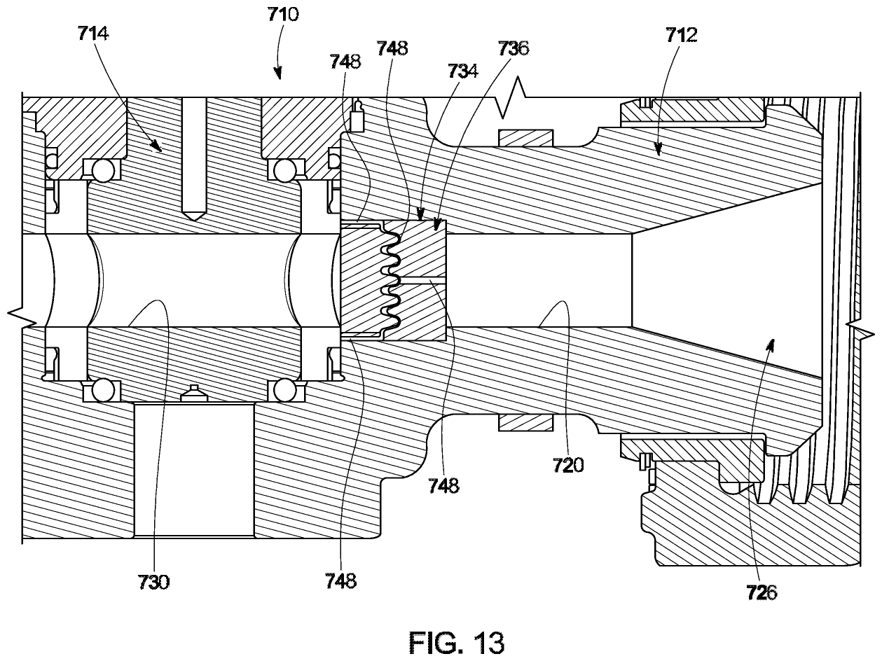

FIG. 13 illustrates another embodiment of a flow restrictor 734 for use with a plug valve 710. In the exemplary embodiment of the flow restrictor 734, a restrictor body 736 of the flow restrictor 734 defines an insert that is partially held within an internal bore 720 of a valve body 712 of the plug valve 710. In the example of FIG. 13, the restrictor body 736 is held within the internal bore 720 downstream from a plug 714 of the plug valve 710. In other embodiments, the restrictor body 736 is held within the internal bore 720 upstream from the plug 714. In still other embodiments, the flow restrictor 734 can be mounted to the valve body 712 in fluid communication with the internal bore 720 at a fluid inlet (not shown) of the plug valve 710 or at a fluid outlet 726 of the plug valve 710. In yet other embodiments, the flow restrictor 734 can be held within a passageway 730 of the plug 714.

The flow restrictor 734 is configured to reduce the pressure of fluid flowing through the flow restrictor 734 and thereby through the plug valve 710. More particularly, the restrictor body 736 includes an internal fluid passage 748 that both has a size (e.g., a width, a diameter, etc.) that is smaller than the size (e.g., width, diameter, etc.) of the internal bore 720 of the valve body 712 and follows a tortuous path through the restrictor body 736, as can be seen in FIG. 13. The smaller size and tortuous path of the internal fluid passage 748 reduces the pressure of fluid flowing through the internal bore 720 (and thus the plug valve 710) by reducing the velocity energy of the fluid flow. In some examples, the restrictor body 736 is configured to provide a laminar, transition, and/or turbulent fluid flow downstream from the flow restrictor 734. The size and path of the internal fluid passage 748 can be selected to provide a predetermined pressure reduction, maximum velocity, and/or the like.

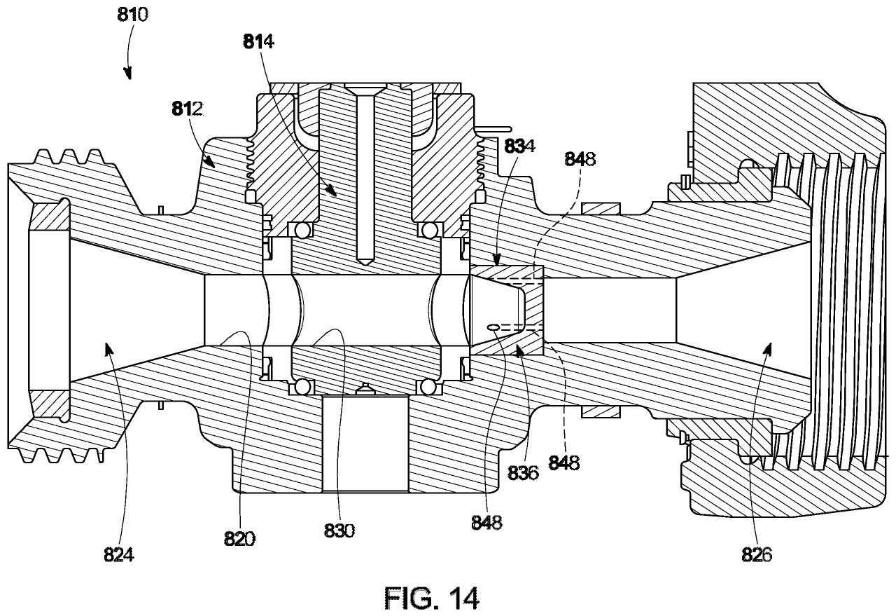

FIG. 14 illustrates another embodiment of a flow restrictor 834 for use with a plug valve 810. A restrictor body 836 of the flow restrictor 834 is an insert that is partially held within an internal bore 820 of a valve body 812 of the plug valve 810 in the exemplary embodiment. The restrictor body 836 is shown as being held within the internal bore 820 downstream from a plug 814 of the plug valve 810, but the restrictor body 836 can be held within the internal bore 820 upstream from the plug 814. In other embodiments, the flow restrictor 834 can be mounted to the valve body 812 in fluid communication with the internal bore 820 at a fluid inlet 824 of the plug valve 810 or at a fluid outlet 826 of the plug valve 810. In still other embodiments, the flow restrictor 834 can be held within a passageway 830 of the plug 814.

The flow restrictor 834 is configured to reduce the pressure of fluid flowing through the flow restrictor 834 and thereby through the plug valve 810. More particularly, the restrictor body 836 includes one or more fluid passages 848 that are reduced in size (e.g., width, diameter, etc.) as compared to the internal bore 820 of the valve body 812, as can be seen in FIG. 14. The smaller sizes of the fluid passages 848 provide a restriction that reduces the pressure of fluid flowing through the internal bore 820 and thereby the plug valve 810 by reducing the velocity energy of the fluid flow. In some examples, the restrictor body 836 is configured to provide a laminar, transition, and/or turbulent fluid flow downstream from the flow restrictor 834. The size and number of the internal fluid passages 848 can be selected to provide a predetermined pressure reduction, maximum velocity, and/or the like.

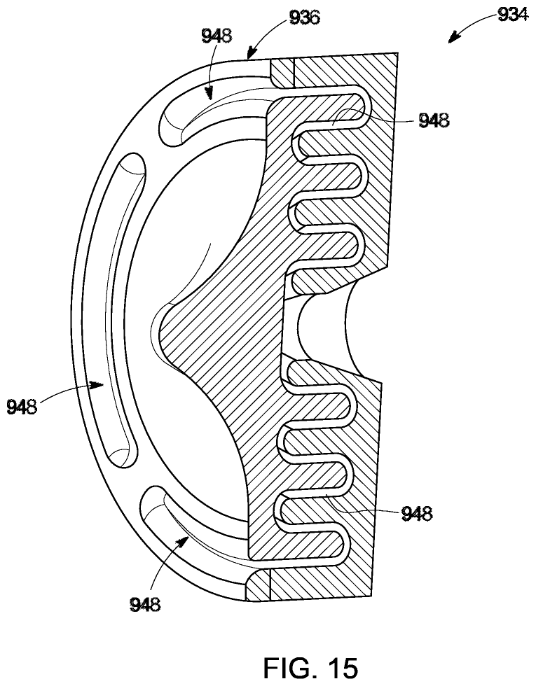

FIG. 15 illustrates another embodiment of a flow restrictor 934 for use with a plug valve (not shown). In the exemplary embodiment of the flow restrictor 934, a restrictor body 936 of the flow restrictor 934 is an insert that is configured to be at least partially held within an internal bore (not shown) of a valve body (not shown) of the plug valve downstream or upstream from a plug (not shown) of the plug valve. In other embodiments, the restrictor body 936 is configured to be mounted to the valve body in fluid communication with the internal bore at a fluid inlet (not shown) of the plug valve or at a fluid outlet of the plug valve. In yet another embodiment, the flow restrictor 934 can be held within a passageway (not shown) of the plug of the plug valve.

The flow restrictor 934 is configured to reduce the pressure of fluid flowing through the flow restrictor 934 and thereby through the plug valve. More particularly, the restrictor body 936 includes an internal fluid passage 948 that has a size (e.g., width, diameter, etc.) that is smaller as compared to the internal bore of valve body. The internal fluid passage 948 also follows a tortuous path through the restrictor body 936, as can be seen in FIG. 15. The smaller size and tortuous path of the internal fluid passage 948 reduces the pressure of fluid flowing through the restrictor body 936 (and thereby through the plug valve) by reducing the velocity energy of the fluid flow. In some examples, the restrictor body 936 is configured to provide a laminar, transition, and/or turbulent fluid flow downstream from the flow restrictor 934. The size and path of the internal fluid passage 948 can be selected to provide a predetermined pressure reduction, maximum velocity, and/or the like.

The following clauses describe further aspects of the disclosure:

### Clause Set A:

A1. A flow restrictor for a plug valve, said flow restrictor comprising:

a restrictor body configured to be at least one of held within an internal bore of a valve body of the plug valve or mounted to the valve body in fluid communication with the internal bore, the restrictor body comprising a plurality of fluid passages extending through a length of the restrictor body, wherein the fluid passages comprise turns such that the fluid passages define tortuous fluid paths through the restrictor body.

A2. The flow restrictor of clause A1, wherein the fluid passages are configured to reduce a pressure of fluid flowing through the restrictor body.

A3. The flow restrictor of clause A1, wherein the restrictor body is configured to be held by a plug of the plug valve, the restrictor body comprising a cluster of a plurality of spherical members, wherein openings extending between the spherical members define the fluid passages.

A4. The flow restrictor of clause A1, wherein the restrictor body is configured to be held by a plug of the plug valve, the restrictor body comprising a cluster of a plurality of spherical members and an end cap configured to extend between the spherical members and the internal bore of the valve body of the plug valve, the end cap comprising at least one opening extending therethrough.

A5. The flow restrictor of clause A1, further comprising a conduit having an internal passageway, the conduit being configured to be mounted to the valve body of the plug valve such that the internal passageway fluidly communicates with the internal bore of the valve body, wherein the restrictor body is held within the internal passageway of the conduit.

A6. The flow restrictor of clause A1, further comprising a conduit having an internal passageway, the conduit being configured to be mounted to the valve body of the plug valve such that the internal passageway fluidly communicates with the internal bore of the valve body, the restrictor body being held within the internal passageway of the conduit, wherein at least some of the turns of the fluid passages have an angle of approximately 90°.

### Clause Set B:

B1. A plug valve comprising:

a valve body having an internal bore configured to receive a flow of fluid therethrough; and

a plug held by the body such that at least a portion of the plug extends within the internal bore of the valve body, the plug comprising a passageway extending therethrough, the plug being rotatable between an open position and a closed position, the passageway of the plug being aligned with the internal bore of the valve body in the open position such that the passageway is in fluid communication with the internal bore in the open position of the plug, the plug forming an obstruction in the closed position such that the closed position of the plug is configured to prevent fluid from flowing through the internal bore of the valve body, the plug comprising a flow restrictor extending within passageway, wherein the flow restrictor comprises a cluster of a plurality of spherical members.

B2. The plug valve of clause B1, wherein the flow restrictor is configured to reduce a pressure of fluid flowing through the internal bore of the valve body.

B3. The plug valve of clause B1, wherein openings are defined between the spherical members, the openings defining fluid passages that define tortuous fluid paths through the passageway of the plug.

B4. The plug valve of clause B1, wherein the spherical members are arranged within the passageway of the plug in a plurality of columns and rows.

B5. The plug valve of clause B1, wherein at least one spherical member has a different size as compared to at least one other spherical member.

B6. The plug valve of clause B1, wherein the flow restrictor comprises an end cap extending between the spherical members and the internal bore of the valve body, the end cap comprising at least one opening extending therethrough.

B7. The plug valve of clause B1, wherein the spherical members comprise steel.

### Clause Set C:

C1. A flow restrictor for a plug valve, said flow restrictor comprising:

a conduit comprising an internal passageway, the conduit being configured to be mounted to a valve body of the plug valve such that the internal passageway fluidly communicates with an internal bore of the valve body; and

a restrictor body held within the internal passageway of the conduit, the restrictor body comprising a plurality of fluid passages extending through a length of the restrictor body, wherein the fluid passages comprise turns such that the fluid passages define tortuous fluid paths through the restrictor body.

C2. The flow restrictor of clause C1, wherein the fluid passages are configured to reduce a pressure of fluid flowing through the internal passageway of the conduit.

C3. The flow restrictor of clause C1, wherein at least some of the turns of the fluid passages have an angle of approximately 90°.

C4. The flow restrictor of clause C1, wherein at least some of the turns of the fluid passages have an angle of less than approximately 90°.

C5. The flow restrictor of clause C1, wherein each of the turns of the fluid passages has an angle of approximately 90°.

C6. The flow restrictor of clause C1, wherein the conduit is configured to be mounted to the valve body of the plug valve downstream from a fluid outlet of the plug valve.

C7. The flow restrictor of clause C1, wherein the restrictor body comprises steel.

It is to be understood that the above description is intended to be illustrative, and not restrictive. For example, the above-described embodiments (and/or aspects thereof) may be used in combination with each other. Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Further, each independent feature or component of any given assembly may constitute an additional embodiment. In addition, many modifications may be made to adapt a particular situation or material to the teachings of the disclosure without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the disclosure should, therefore, be determined with reference to the appended claims, along with the full scope of equivalents to which such claims are entitled.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “clockwise” and “counterclockwise”, “left” and right”, “front” and “rear”, “above” and “below” and the like are used as words of convenience to provide reference points and are not to be construed as limiting terms.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. For example, in this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised”, “comprises”, “having”, “has”, “includes”, and “including” where they appear. The term “exemplary” is intended to mean “an example of” The phrase “one or more of the following: A, B, and C” means “at least one of A and/or at least one of B and/or at least one of C.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

Although the terms “step” and/or “block” may be used herein to connote different elements of methods employed, the terms should not be interpreted as implying any particular order among or between various steps herein disclosed unless and except when the order of individual steps is explicitly described. The order of execution or performance of the operations in examples of the disclosure illustrated and described herein is not essential, unless otherwise specified. The operations may be performed in any order, unless otherwise specified, and examples of the disclosure may include additional or fewer operations than those disclosed herein. It is therefore contemplated that executing or performing a particular operation before, contemporaneously with, or after another operation is within the scope of aspects of the disclosure.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A flow restrictor for a plug valve, said flow restrictor comprising:
a restrictor body configured to be at least one of held within an internal bore of a valve body of the plug valve or mounted to the valve body in fluid communication with the internal bore, the restrictor body comprising a plurality of fluid passages extending through a length of the restrictor body, wherein the fluid passages comprise turns such that the fluid passages define tortuous fluid paths through the restrictor body.

2. The flow restrictor of claim 1, wherein the fluid passages are configured to reduce a pressure of fluid flowing through the restrictor body.

3. The flow restrictor of claim 1, wherein the restrictor body is configured to be held by a plug of the plug valve, the restrictor body comprising a cluster of a plurality of spherical members, wherein openings extending between the spherical members define the fluid passages.

4. The flow restrictor of claim 1, wherein the restrictor body is configured to be held by a plug of the plug valve, the restrictor body comprising a cluster of a plurality of spherical members and an end cap configured to extend between the spherical members and the internal bore of the valve body of the plug valve, the end cap comprising at least one opening extending therethrough.

5. The flow restrictor of claim 1, further comprising a conduit having an internal passageway, the conduit being configured to be mounted to the valve body of the plug valve such that the internal passageway fluidly communicates with the internal bore of the valve body, wherein the restrictor body is held within the internal passageway of the conduit.

6. The flow restrictor of claim 1, further comprising a conduit having an internal passageway, the conduit being configured to be mounted to the valve body of the plug valve such that the internal passageway fluidly communicates with the internal bore of the valve body, the restrictor body being held within the internal passageway of the conduit, wherein at least some of the turns of the fluid passages have an angle of approximately 90°.

7. A plug valve comprising:
a valve body having an internal bore configured to receive a flow of fluid therethrough; and
a plug held by the body such that at least a portion of the plug extends within the internal bore of the valve body, the plug comprising a passageway extending therethrough, the plug being rotatable between an open position and a closed position, the passageway of the plug being aligned with the internal bore of the valve body in the open position such that the passageway is in fluid communication with the internal bore in the open position of the plug, the plug forming an obstruction in the closed position such that the closed position of the plug is configured to prevent fluid from flowing through the internal bore of the valve body, the plug comprising a flow restrictor extending within passageway, wherein the flow restrictor comprises a cluster of a plurality of spherical members.

8. The plug valve of claim 7, wherein the flow restrictor is configured to reduce a pressure of fluid flowing through the internal bore of the valve body.

9. The plug valve of claim 7, wherein openings are defined between the spherical members, the openings defining fluid passages that define tortuous fluid paths through the passageway of the plug.

10. The plug valve of claim 7, wherein the spherical members are arranged within the passageway of the plug in a plurality of columns and rows.

11. The plug valve of claim 7, wherein at least one spherical member has a different size as compared to at least one other spherical member.

12. The plug valve of claim 7, wherein the flow restrictor comprises an end cap extending between the spherical members and the internal bore of the valve body, the end cap comprising at least one opening extending therethrough.

13. The plug valve of claim 7, wherein the spherical members comprise steel.

14. A flow restrictor for a plug valve, said flow restrictor comprising:
a conduit comprising an internal passageway, the conduit being configured to be mounted to a valve body of the plug valve such that the internal passageway fluidly communicates with an internal bore of the valve body; and
a restrictor body held within the internal passageway of the conduit, the restrictor body comprising a plurality of fluid passages extending through a length of the restrictor body, wherein the fluid passages comprise turns such that the fluid passages define tortuous fluid paths through the restrictor body.

15. The flow restrictor of claim 14, wherein the fluid passages are configured to reduce a pressure of fluid flowing through the internal passageway of the conduit.

16. The flow restrictor of claim 14, wherein at least some of the turns of the fluid passages have an angle of approximately 90°.

17. The flow restrictor of claim 14, wherein at least some of the turns of the fluid passages have an angle of less than approximately 90°.

18. The flow restrictor of claim 14, wherein each of the turns of the fluid passages has an angle of approximately 90°.

19. The flow restrictor of claim 14, wherein the conduit is configured to be mounted to the valve body of the plug valve downstream from a fluid outlet of the plug valve.

20. The flow restrictor of claim 14, wherein the restrictor body comprises steel.
